(19) United States
(12) Patent Application Publication
(10) Pub. No.: US 2012/0007579 A1
(43) Pub. Date: Jan. 12, 2012

(54) EMBEDDED WIRELESS CORROSION SENSOR

(76) Inventors: ALLEN WALLACE APBLETT, Stillwater, OK (US); M. TYLER LEY, Stillwater, OK (US); NICHOLAS FERDINAND MATERER, Stillwater, OK (US)

(21) Appl. No.: 12/834,626

(22) Filed: Jul. 12, 2010

(51) Int. Cl. G01N 27/00

(52) U.S. Cl. 324/71.1

(57) ABSTRACT

A corrosion sensor is disclosed. The corrosion sensor has a retainer and a microcontroller retained by the retainer. A length of antenna wire arranged in a wound configuration is retained by the retainer and connected to the microcontroller. A corrosion sensitive element is conductively connected to the microcontroller. The microcontroller is programmed to receive a power signal from the antenna wire and test for corrosion of the corrosion sensitive element. The he microcontroller is also programmed to transmit a signal indicative of the test results via the antenna.

### FIELD OF THE INVENTION

This disclosure relates corrosion sensors in general and more particularly, but not by way of limitation, to wireless corrosion sensors, systems, and methods.

### BACKGROUND OF THE INVENTION

Almost every man made construction is subject to corrosive forces. Corrosion affects aircraft, trains, automobiles, pipelines, factories, and a host of other devices, buildings, structures, and apparatus. In the United States alone, costs associated with policing and repair of corrosion runs into the hundreds of billions of dollars. Industrial segments including transportation, utilities, production and manufacturing, governments, and other infrastructure have a need to detect corrosion prior to significant damage occurring to the structure of interest.

Currently, it is not feasible to locate corrosion on reinforcing steel until corrosion has already developed and caused cracking of the surrounding concrete from the rust products. Once surface cracking of the concrete has occurred, an investigation into the deterioration is time-consuming and destructive to the element as cores are taken to investigate the surface of the reinforcing steel. This work requires lane closures, causes traffic delays, and involves elevated safety risks for maintenance crews and the traveling public.

What is needed is a system and method for addressing the above and related concerns.

### SUMMARY OF THE INVENTION

The invention of the present disclosure, in one aspect thererof, comprises corrosion sensor. The corrosion sensor has a retainer and a microcontroller retained by the retainer. A length of antenna wire arranged in a wound configuration is retained by the retainer and connected to the microcontroller. A corrosion sensitive element is conductively connected to the microcontroller. The microcontroller is programmed to receive a power signal from the antenna wire and test for corrosion of the corrosion sensitive element. The microcontroller is also programmed to transmit a signal indicative of the test results via the antenna.

In some embodiments, the retainer is shaped substantially as a disc with an exterior track around a periphery of the disc retaining the antenna and an interior cavity near a center of the disc retaining the microcontroller. The antenna may be copper. The microcontroller may tests the corrosion sensitive element by testing continuity of the corrosion sensitive element. The microcontroller may communicates on a frequency of about 125 kHz.

The corrosion sensor may have a plurality of corrosion sensitive elements conductively connected to the microcontroller. The plurality of corrosion sensitive elements may be utilized by the microcontroller to determine a degree of corrosion. The microcontroller may transmit identifying information, including location information.

In some embodiments the corrosion sensor may include a support bracket for placing the retainer proximate a predetermined location on a test object. In other embodiments, the sensor may include concrete block attached to the retainer, and adapted to be enclosed within a concrete structure during assembly of the concrete structure.

The invention of the present disclosure, in another aspect thereof; comprises a method of detecting corrosion of a metal support structure within a concrete structure. A non-conductive testing retainer having an outer periphery with a copper winding antenna is provided along with a programmable microcontroller retained by the testing retainer. The microcontroller is conductively attached to the antenna for receiving power and transmitting data. A test element is attached to the microcontroller. The testing retainer is placed into the concrete structure proximate a portion of the metal support structure. A power signal is provided to the microcontroller via the antenna. The test element is tested by the microcontroller, and the results are received wirelessly from the microcontroller via the antenna.

In some embodiments, placing the testing retainer into the concrete structure proximate a portion of the metal support structure further occurs before the concrete is cured. A plurality of test elements may be connected to the microcontroller. In some cases a plurality of testing retainers may be placed on the metal support structure at known depths within the concrete structure to monitor for corrosion of the support structure at a plurality of locations and depths within the concrete structure. The testing retainer may be pre-assembled into a concrete block for handling when placing into the concrete structure.

### BRIEF DESCRIPTION OF THE DRAWINGS

FIG. 1 is a schematic diagram of a wireless corrosion sensor according to aspects of the present disclosure.

FIG. 2 is a perspective view of a wireless corrosion sensor according to aspects of the present disclosure.

FIG. 3 is a side view of a wireless corrosion sensor clamped to structural rebar according to aspects of the present disclosure.

FIG. 4 is a perspective view of a corrosion sensitive concrete block according to aspects of the present disclosure.

FIG. 5 is a side view of a bridge structure containing a plurality of embedded wireless corrosion sensors according to aspects of the present disclosure.

### DETAILED DESCRIPTION OF THE PREFERRED EMBODIMENTS

Early detection of corrosion of steel reinforcement in concrete, through the use of sensors described herein, may help to preserve structural integrity of concrete structures. Such structures may include bridges and roadways but may also include occupied structures such as buildings and stadium. The sensors described herein may reduce the risk of substantial section loss or fatigue failure that is initiated by corrosion damage. Until now, it has not been feasible to locate corrosion on reinforcing steel until corrosion was already developed and caused cracking of the surrounding concrete from the rust products. Once surface cracking of the concrete has occurred, an investigation into the deterioration is time-consuming and destructive to the element as cores are taken to investigate the surface of the reinforcing steel. In the case of highways and bridges, this work requires lane closures, causes traffic delays, and involves elevated safety risks for maintenance crews and the traveling public. Thus, embedded wireless monitoring as described herein will increase the safety of the workers and reduce delays, as well as provide the owner with crucial information about the health of the structure. This information may be used to intelligently schedule maintenance to optimize resources or to modify the current uses of the structure to prolong its life. In one example, it is estimated that the use of the presently disclosed sensors will allow the engineers to employ “best maintenance practices” that are estimated to save 46 percent of the annual corrosion cost of a black steel rebar bridge deck, or $2,000 per bridge per year.

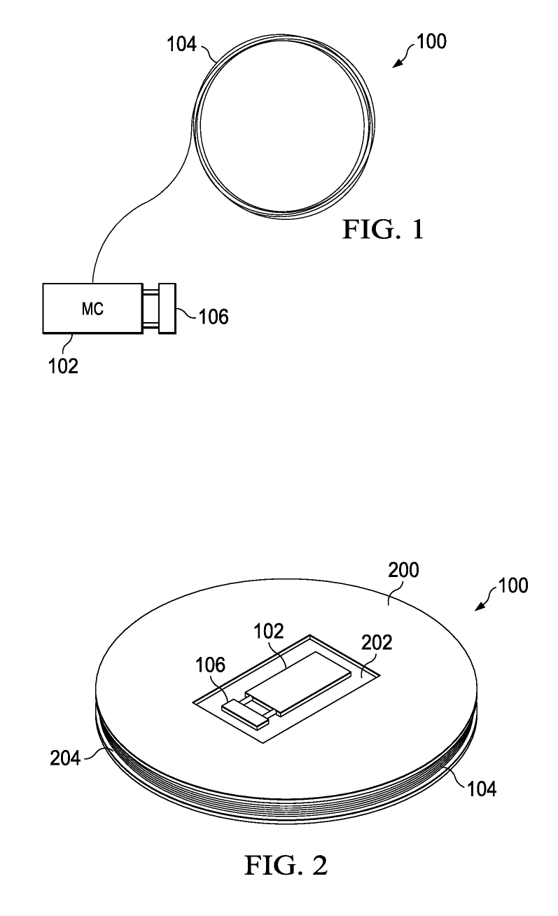

Referring now to FIG. 1, a schematic diagram of a wireless corrosion sensor is shown. The sensor 100 is passive in that it does not contain a power source and may remain inactive until energized by radiofrequency, magnetic, microwave, or other wireless energy fields. In the present embodiment, the sensor 100 is based upon radio frequency identification (RFID) technology. In the present embodiment, the sensor 100 is based upon a microcontroller 102 that is programmed to operate in accordance with known RFID protocols such that commercially available RFID readers can be utilized. In the present embodiment, an 8-bit PIC Microcontroller such as the pic12F683 from Microchip Technology, Inc. is used. However, other ultra low powered microcontrollers capable of being powered by RF energy could be utilized. In other embodiments, the sensor 100 may be based on known and commercially available RFID tag circuits suitably modified to meet the demands of the user. In U.S. Pat. No. 7,675,295 (hereby incorporated by reference) it was shown how an off-the-shelf commercial RFID tag could be modified to monitor for corrosion. The present disclosure describes, among other things, how commercial RFID protocols can be implemented in a sensor that monitors for corrosion of a metallic structure that may be deeply embedded within concrete and other building materials.

In order to successfully operate with commercial RFID tag readers, the sensor 100 must communicate with an RFID tag reader using a protocol that is known to the reader. However, this communication must take place through layers of concrete and other building materials. Furthermore, if the sensor 100 is to be passive and avoid the need for a battery or other power source that would be subject to failure, the sensor 100 must be powered by energy received from the reader itself.

An RFID reader or scanner will transmit microwave, magnetic, or radiofrequency energy to the sensor 100. Some RFID systems rely upon load modulation or reflected power/backscatter technology. One standard that can be used for RFID is the ISO/IEC 18000 RFID Air Interface Standard. However, other suitable protocols may be implemented or developed for use with the sensors of the present disclosure.

Although the sensor 100 the present disclosure may be able to operate with RFID systems of almost any frequency, the intended use of the sensor 100, being buried within a concrete structure, may dictate that the most useful frequencies are along the order of kilohertz rather than in the megahertz bands. In one embodiment, the frequency will be about 125 KHz. At this frequency, the supplied energy may come from magnetic induction in the near field range. The 125 KHz frequency is virtually transparent to soil, concrete, paper, water, conductive liquids and slurries.

Sensors of the present disclosure that operate at low frequencies in the near field will rely on an alternating current in a scanner coil (not shown) to induce a current in an antenna coil 104. This current may be used to power the microcontroller 102. When the sensor 100 has been powered, information contained within the sensor 100 may be sent back to the scanner by load modulation. In load modulation, the loading of the sensor's coil is changed in a pattern over time that affects the current being drawn by the scanner coil. In order to recover the information or identity transmitted by the sensor 100, the scanner decodes the change in current as a varying potential developed across a series of internal resistors (not shown).

The boundary of the near field and far field is governed by the frequency of the alternating current used to energize the coils of the scanner. The boundary is approximately limited to a distance of C/2.pi.f, where C equals the speed of light and f equals the frequency. Depending upon the location of the sensor 100 and/or the test object, relatively larger scanners and/or sensors 100 may be utilized to increase the effective communication distance.

Rather than the usual flat or square antenna utilized by many commercial RFID tags, the sensor 100 employs a coiled copper antenna 104. The coiled copper antenna 104 allows for sufficient power to be received by the antenna 104 even when operating buried in several inches of concrete or other building materials. Moreover, the coiled copper antenna 104 also allows for sufficient data transfer back through the concrete to the RFID reader via load modulation or other methods. A relatively low Q coil may be required to function properly with certain RFID readers. In one embodiment a 30 mm coil diameter will be used. It is also understood that copper is used as an example here but an appropriate antenna could be constructed from other metals or conductors.

A corrosion sensitive element 106 may be connected across one or more leads of the microcontroller 102. In one embodiment, the microcontroller will test the continuity or resistance of the corrosion sensitive element to determine whether or not corrosion is resistant. If the resistance of the element 106 is infinite (or very large) it may be corroded to a significant degree. The microprocessor's 102 programming may be relatively simple in that it's only task upon being powered by the antenna coil 104 is to test the continuity of the element 106 and report this status back via RFID protocol. However, other information could also be provided back to the reader including an identification number, and installation date, or even a location. In a structure with a plurality of embedded sensors 100, being able to determine the location of the reporting sensor could be useful. Additionally, the microcontroller programming may provide for anti-collision schemes or other methods to allow for reliable communication from more than one sensor 100 in range of a single RFID reader.

The material comprising the test link or corrosion sensitive element 106 may vary according to the underlying material of the test object. For example, if a sensor is employed to detect corrosion on rebar structures within a concrete bridge, the link 106 may comprise a medium carbon wire. In some cases, it may be desirable to detect corrosion long before the test structure becomes corroded, or to refrain from reporting minor amounts of corrosion while monitoring for catastrophic corrosion. In such case, the link material 106 could be selected have a corrosion sensitivity that is greater or less, respectively, than the underlying structure. The thickness of the link 106 can also be varied in order to detect corrosion at a threshold level. In other embodiments, multiple link 106 of varying thicknesses could be used that would allow the microprocessor 102 to determine not only presence of corrosion, but a relative degree of corrosion. This could then be reported back to the RFID reader.

Referring now to FIG. 2, a perspective view of a wireless corrosion sensor according to aspects of the present disclosure is shown. In the present embodiment, the sensor 100 has been packaged into a component suitable for embedding within a concrete structure in a location where corrosion detection is needed. A retainer 200 is provided that defines a hole or depression 202 into which the microprocessor 102 and possibly the corrosion sensitive link 106 may be placed. A track 204 may be defined around a peripheral edge of the retainer 200 for retaining the antenna coil 104. In the present embodiment, the retainer 200 is substantially disk shaped and defines a cavity 202 near the center thereof. However, the retainer 200 need not necessarily be configured in this way. For example, the microprocessor 102 and corrosion sensitive element 106 could be surface-mounted on an outside of the retainer 200. Similarly, the antenna coil 104 need not necessarily be placed in a peripheral track 204. However, the present embodiment does present a compact and durable method of retaining all of the required elements of the sensor 100.

In some embodiments, the retainer 200 will be comprised of Delrin®. However, in other embodiments, other plastics or nonconductive materials could be utilized. Following assembly of the sensor 100, the unit may be coated with a sealant while leaving the corrosion sensitive element 106 exposed in order to detect corrosion. In such an embodiment, the microprocessor 102 and the antenna coil 104 would remain operational long after the corrosion sensitive link 106 were severely corroded or even gone. In some embodiments, the sensor 100 may be coated, at least in part, with a flexible plastic in order to eliminate stress points within the concrete structure that may result from the presence of the sensor 100.

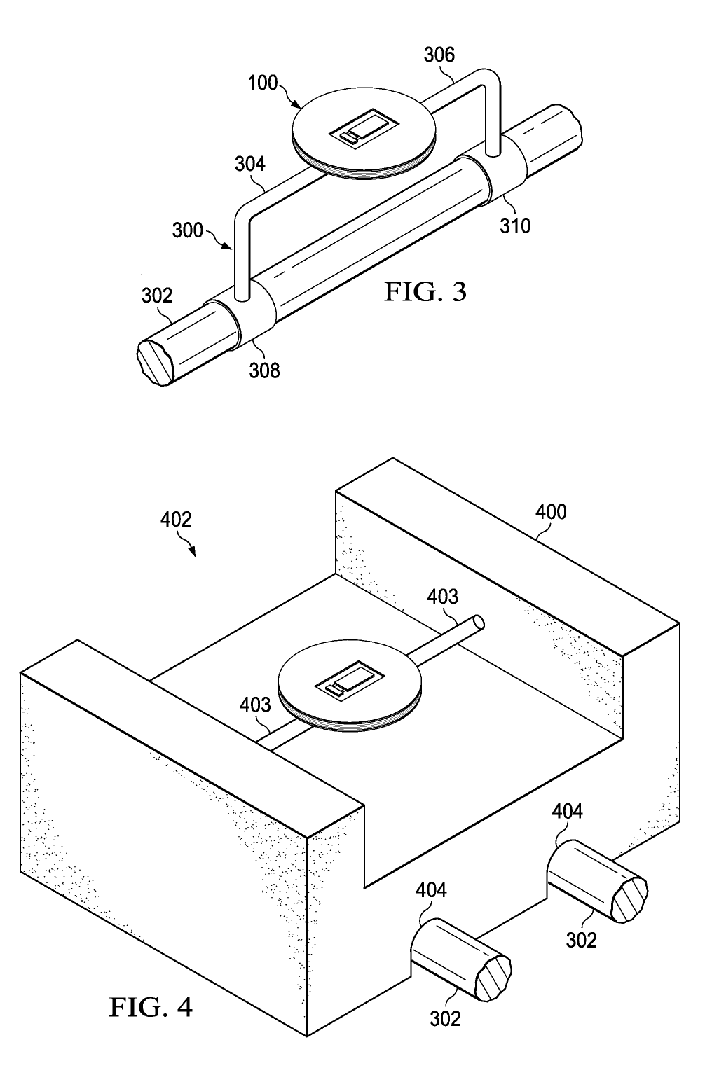

Referring now to FIG. 3, a side view of a wireless corrosion sensor 100 clamped to a segment of structural rebar 302 according to aspects of the present disclosure is shown. In many cases, it may be desirable to retain a corrosion sensor 100 securely in a known location along the structure being monitored. In the present embodiment, a retaining element 300 is provided that retains the corrosion sensor 100 in a relative position on a segment of rebar 302. In the present embodiment, legs 304 and 306 connect on substantially opposite sides of the sensor 100 to clamps 308, 310, respectively. In some embodiments, the retaining element 300 may be plastic or another suitably resilient material.

Referring now to FIG. 4, a perspective view of a corrosion sensitive concrete block according to aspects of the present disclosure is shown. Here, the concrete block provides a depression or cutout 402. The sensor 100 is suspended on arms 403 within the cutout 402. Forming the block 400 in this matter will allow the sensor 100 to be in direct contact with the concrete of the monitored structure. This will allow for more accurate assessment of corrosion as the concrete of the structure may have different properties (e.g., pH, permeability, mix ingredients) than that of the block 400. Channels or recesses 404 may be provided for fitting the block 400 onto structural rebar 302 or other structural material. Clamps (not shown) may also be provided to assist in retention of the block 400 on the monitored structure.

A number of blocks 400 may be embedded throughout a concrete structure when it is being assembled. The block 400 provides on way that the sensor 100 may be transported and handled with less fear of damage. In some embodiments, the sensor 100 may be entirely buried within the block. In another embodiment, the retainer 300 of FIG. 3 will be buried within a concrete block, possibly with clamps 308, 310 exposed for attachment to the structure. The concrete block 400 may be labeled with an assembly date or a location indicator which may also be programmed into the sensor 100, as previously described.

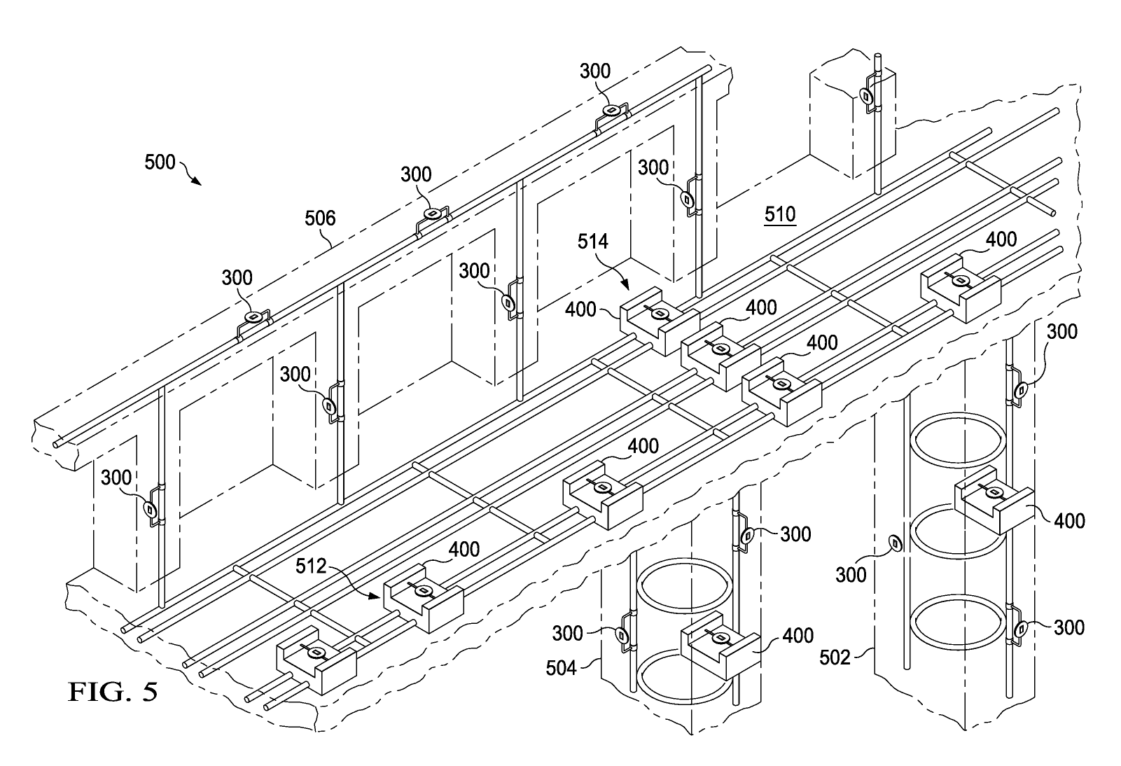

Referring now to FIG. 5, a side view of a bridge structure containing a plurality of embedded wireless corrosion sensors according to aspects of the present disclosure is shown. The bridge structure 500 is only one non-limiting example of the manner in which the passive wireless corrosion sensors of the present disclosure may be utilized. In the present example, the bridge structure 500 defines a road surface 501 and pillars 502, 504. A concrete railing 506 is also provided and the entire concrete structure may be framed from within by a steel framework 510.

It can be seen in FIG. 5 that wireless corrosion sensors, as described herein, may be placed throughout the structure 500 in order to detect corrosion and levels of corrosion wirelessly and non-destructively. For example, multiple wireless corrosion sensors may be placed beneath the road surface 501 in order to inform when corrosion of the steel structure 510 beneath the road surface 501 is occurring. In this way, the remaining life span of the road surface 501 can be determined in a non-destructive way. In some embodiments, a plurality of wireless corrosion sensors 400 may be arranged in a stack 514. The corrosion sensors within the stack 514 may be placed at varying depths such that the precise location of corrosion of the steel structure 510 underlying the road surface 501 can be determined. Similarly, sensors may be placed within the pillars 502, 504. In this way, the internal corrosion level of the structure support members can be determined. In some cases, for example, only the surface of the road 501 may have a significant degree of corrosion while the pillars 502, 504 may be essentially sound. A determination of this may mean that the entire structure need not necessarily be disassembled and repaired.

It is understood that, within a single structure such as bridge structure 500, multiple versions of the wireless corrosion sensors of the present disclosure may be utilized. For example, a sensor 100 may simply be embedded within the concrete, or it may be attached to a retaining member 300, or it may be previously embedded in a concrete block 400, which is then constructed into the structure 500. The location and configuration of the sensor 100 may be determined based upon the needs of the user. For example, in some structures, only corrosion of critical locations such as a high stress area 512 may be monitored.

In some embodiments, to determine the state of corrosion within the structure 500, a technician may traverse the bulk of the structure using a hand-held RFID reader. As the reader is placed in the vicinity of each of the wireless corrosion sensors, the sensors may report their identification, location, n and/or state of corrosion within their area. In other embodiments, large readers may be constructed in order to speed up such a process. For example, a large truck-mounted reader may be capable of quickly scanning the entire road surface 501 in a relatively short amount of time.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

What is claimed is:

1. A corrosion sensor comprising:
a retainer;
a microcontroller retained by the retainer;
a length of antenna wire arranged in a wound configuration retained by the retainer and connected to the microcontroller; and
a corrosion sensitive element conductively connected to the microcontroller;
wherein the microcontroller is programmed to receive a power signal from the antenna wire and test for corrosion of the corrosion sensitive element; and
wherein the microcontroller is programmed to transmit a signal indicative of the test results via the antenna.

2. The corrosion sensor of claim 1, wherein the retainer is shaped substantially as a disc with an exterior track around a periphery of the disc retaining the antenna and an interior cavity near a center of the disc retaining the microcontroller.

3. The corrosion sensor of claim 1, wherein the microcontroller tests the corrosion sensitive element by testing continuity of the corrosion sensitive element.

3. The corrosion sensor of claim 1, wherein the microcontroller communicates on a frequency of about 125 kHz.

4. The corrosion sensor of claim 1, wherein a plurality of corrosion sensitive elements are conductively connected to the microcontroller.

5. The corrosion sensor of claim 4, wherein the plurality of corrosion sensitive elements are utilized by the microcontroller to determine a degree of corrosion.

6. The corrosion sensor of claim 1, wherein the microcontroller transmits identifying information.

7. The corrosion sensor of claim 6, wherein the identifying information contains location information.

8. The corrosion sensor of claim 1, wherein the antenna wire comprises copper.

9. The corrosion sensor of claim 1, further comprising a support bracket for placing the retainer proximate a predetermined location on a test object.

10. The corrosion sensor of claim 1, further comprising a concrete block attached to the retainer, and adapted to be enclosed within a concrete structure during assembly of the concrete structure.

11. A corrosion sensor comprising:
a corrosion sensor comprising:
a housing defining an antenna track;
a microcontroller retained by the retainer and providing at least one corrosion sensitive element conductively connected therewith; and
a copper wire antenna arranged in a wound configuration in the antenna track and connected to the microcontroller; and
a concrete encasement attached to the housing;
wherein the microcontroller is programmed to receive a power signal from the antenna wire and test for corrosion of the at least one corrosion sensitive element; and
wherein the microcontroller is programmed to transmit a signal indicative of the test results via the antenna.

12. The corrosion sensor of claim 11, further comprising clamps for attaching the concrete encasement onto a steel support structure being monitored, before the support structure is case in concrete.

13. The corrosion sensor of claim 11, wherein the antenna track is substantially circular shaped.

14. The corrosion sensor of claim 11, wherein the housing is substantially disc shaped.

15. The corrosion sensor of claim 11, wherein the microcontroller selectively transmits identifying information via the antenna.

16. A method of detecting corrosion of a metal support structure within a concrete structure comprising;
providing a non-conductive testing retainer having an outer periphery with a copper winding antenna;
providing a programmable microcontroller retained by the testing retainer, the microcontroller conductively attached to the antenna for receiving power and transmitting data;
attaching a test element to the microcontroller;
placing the testing retainer into the concrete structure proximate a portion of the metal support structure;
providing a power signal to the microcontroller via the antenna;
testing the test element with the microcontroller; and
receiving test results wirelessly from the microcontroller via the antenna.

17. The method of claim 16, wherein placing the testing retainer into the concrete structure proximate a portion of the metal support structure further comprises placing the testing retainer before the concrete is cured.

18. The method of claim 16, further comprising attaching a plurality of test elements to the microcontroller.

19. The method of claim 16, further comprising placing a plurality of testing retainers in on the metal support structure at known depths within the concrete structure to monitor for corrosion of the support structure at a plurality of locations and depths within the concrete structure.

20. The method of claim 16 further comprising pre-assembling the testing retainer into a concrete block for handling when placing into the concrete structure.
